(19) United States
(12) Patent Application Publication
(10) Pub. No.: US 2008/0173582 A1
(43) Pub. Date: Jul. 24, 2008

(54) Process and apparatus for reuse of liquid effluents generated in the textile finishing, laundering, dyeing and stamping process

(75) Inventors: Rubens Jose de Oliveira Filho, Santos (BR); Leandro Zanini Santos, Santa Barbara D'oeste (BR)

Correspondence Address: TRASK BRITT, P.O. BOX 2550, SALT LAKE CITY, UT, 84110, US

(73) Assignees: Lamberto Jose Ramenzoni, Sao Paulo (BR); Rubens Jose de Oliveria Filho, Santos (BR); Leandro Zanini Santos, Santa Barbara D'oeste (BR)

(21) Appl. No.: 11/807,619

(22) Filed: May 29, 2007

(30) Foreign Application Priority Data
Jan. 22, 2007 (BR) PI 07003745-9

(51) Int. Cl. C02F 9/02; C02F 9/04; C02F 9/14

(52) U.S. Cl. 210/620; 210/806; 210/500.27; 210/641; 210/195.1; 210/266; 210/257.2; 210/196

(57) ABSTRACT

New industrial, commercial and/or household process and the apparatus to carry out that process. Used in water recycling and reuse treatments applied to laundering, dyeing and stamping processes in general, mainly in the textile segment. Today, residues generated by industrial plants must be disposed of in compliance with the national legislation, established by resolutions issued by the National Environment Council of each region and country. As a result, there are several processes for the treatment of residuary water and effluents in several categories. However, to date, there is no specific treatment for effluents of textile industrial plants and/or similar facilities, because each plant uses different chemical components together with their products, which requires different treatments. Consequently, general purpose effluent treatments are more commonly used, but are not always efficient in treating special cases of effluents containing specific residues. Therefore, the present descriptive report introduces a new process and its associated apparatus for reusing liquid effluents generated mainly in textile finishing, laundering, dyeing and stamping processes, as well as for reusing liquid effluents in general that bear the features of textile effluents.

### BACKGROUND OF THE INVENTION

1. Field of the Invention

This report and its explanatory drawings contain a detailed description of a new industrial, commercial and/or household process and the apparatus to carry out that process. They are used in water recycling and reuse treatments applied to laundering, dyeing and stamping processes in general, mainly in the textile segment.

2. State of the Art

Today, residues generated by industrial plants must be disposed of in compliance with the national legislation, established by resolutions issued by the Environment National Council of each region and country. As a result, there are several processes for the treatment of residuary water and effluents in several categories. However, to date, there is no specific treatment for effluents of textile industrial plants and/or similar facilities, because each plant uses different chemical components together with their products, which requires different treatments. Consequently, general purpose effluent treatments are more commonly used, but are not always efficient in treating special cases of effluents containing specific residues. Therefore, the present descriptive report introduces a new process and its associated apparatus for reusing liquid effluents generated mainly in textile finishing, laundering, dyeing and stamping processes, as well as for reusing liquid effluents in general that bear the features of textile effluents.

### BRIEF SUMMARY OF THE INVENTION

The textile finishing industries generate their residues from finishing processes. Effluents are taken to Wastewater Treatment Stations or Systems, where—after complying with all steps and obeying physical-chemical parameters established by law—they will be taken to their final destiny, which are either receptor bodies such as rivers, lakes, streams, etc. or the city sewer system.

These effluents, according to Braile (1993), are generated by the processes to which natural fiber textiles (cotton) and natural fiber combined with synthetic fibers are submitted in the finishing industry. Among them, we have:

Starching: when the crude yarns arrive at the starching units in warp rolls, they pass through a boiled starch flour solution and form starched rolls.

Starch removal and washing: This apparatus is used to soak the textile with enzymes, hot alkaline detergents or soaps and emollients dissolved in water to destroy the starch. After the soaking period (which lasts from two to ten hours at a temperature above 120° C.), the enzymes destroy the amylum. After that, the textile is washed in special washing machines; their wastewater mainly contains products from starch paste decomposition and hydrolysis reagent. Volume is relatively low, but Biochemical Oxygen Demand (BOD) is high, being responsible for 50 percent of the total BOD.

Dyeing: The textile goes through a dye solution, gets fixed and washed. Dyeing is achieved by continuous and discontinuous processes. In the continuous process (the case in study), the textile, after being soaked in a bath containing dye and chemical products, is pressed between two rolls and dried. While the dyeing wastes are of various types, due to different kinds of colorants and the way they are applied, they are also voluminous, have a strong coloration and, in some cases, can be toxic. BOD is usually low but can reach 37 percent of the total load in some plants. Sometimes, these residues show a high immediate demand for oxygen due to the reduction agents used in some baths and dyeing processes.

Finishing: last phase of textile processing. Includes the application of starch and resins that are either dried or fixed under controlled temperatures so that the textile may get the finish requested by the buyer, which is made by mechanical and chemical processes. Waste usually results from washing of mangles (cylinders), machinery and floor. It contains urea, formaldehyde, triphosphate, starch, stearate, Turkey red oil, polyvinyl resins emulsions and magnesium salt.

According to an estimate by Tomaz (2002), water consumption in these industries ranges from 275 to 365 liters of water for each kilogram of bleached textile, and from 35 to 70 liters of water for each kilogram of dyed textile. The following table illustrates the breakdown of water consumption. Caution is advised, however. It must be taken into account that technological innovations can increase or even reduce water consumption.

TABLE 1
Breakdown of water consumption in the textile industry

| Water Use Type | Textile Processing And Dyeing (%) |
|---|---|
| Boiler feeding | 13.00 |
| Cooling by recirculation | 2.00 |
| Direct cooling | 4.00 |
| Humidification | 2.00 |
| Washing of end product | 11.00 |
| Washing of machinery | 2.00 |
| Washing of external areas | 2.00 |
| Domestic use | 4.00 |
| Others | 60.00 |

The following is a general description of the most common industrial washing processes used in general and in laundries of any category:

### Phase 1

Washing using neutral and alkaline (caustic soda base) detergents, as well as potable water. Duration: 7 minutes.

Draining of first water containing detergents diluted in water and dirt extracted from clothes.

### Phase 2

Rinsing with clean water without addition of chemical products; Duration: 3 minutes.

Draining of second water containing traces of detergents: neutral and alkaline, and traces of dirt extracted from clothes.

### Phase 3

Washing with neutral and alkaline detergents (caustic soda base) and potable water supplied by the public water supply department; Duration: 7 minutes.

Draining of third water containing detergents diluted in water and dirt extracted from clothes.

### Phase 4

Rinsing with clean water without addition of chemical products; Duration: 3 minutes.

Draining of fourth water containing traces of detergents: neutral and alkaline and traces of dirt extracted from clothes.

### Phase 5

Disinfection with sodium hypochlorite at 12% diluted in clean water; Duration: 3 minutes.

Draining of fifth water containing a high level of free chlorine.

### Phase 6

Rinsing with clean water without addition of chemical products; Duration: 3 minutes.

Draining of sixth water containing traces of chlorine.

### Phase 7

Rinsing with 250 ml of sodium bisulfite (chlorine neutralizer); Duration: 3 minutes.

Addition of 250 ml of softener; rinsing for another 3 minutes.

Draining of seventh water containing sodium bisulfite and softener.

As a reference for effluent reusing systems, we may mention projects that take into account equipment for Aeration, Flocculation-decantation, and Filtration and Storage Systems. All of them feature low rates (percentage in relation to the total volume of effluents generated) of water reuse throughout the process, and therefore, there is no satisfactory removal of surfactants (soaps), dirt (in laundry houses) and textile supporting products used in the finishing process.

Given this situation, and aiming at finding a solution to the issue of water treatment and reuse of industrial effluents, particularly in the textile industry, to improve process efficiency and performance, as well as to reduce costs, we developed and designed the PROCESS AND APPARATUS FOR REUSE OF LIQUID EFFLUENTS GENERATED IN THE TEXTILE FINISHING, LAUNDERING, DYEING AND STAMPING PROCESS, which is the object of this patent.

### BRIEF DESCRIPTION OF THE SEVERAL VIEWS OF THE DRAWINGS

The figures enclosed in the present descriptive report are explained below to facilitate its understanding and illustrate it.

FIG. 1 shows a diagram of the process and the apparatus for reuse of liquid effluents generated in the textile finishing, laundering, dyeing and stamping process, object of the present patent. The figure includes operational and configuration details.

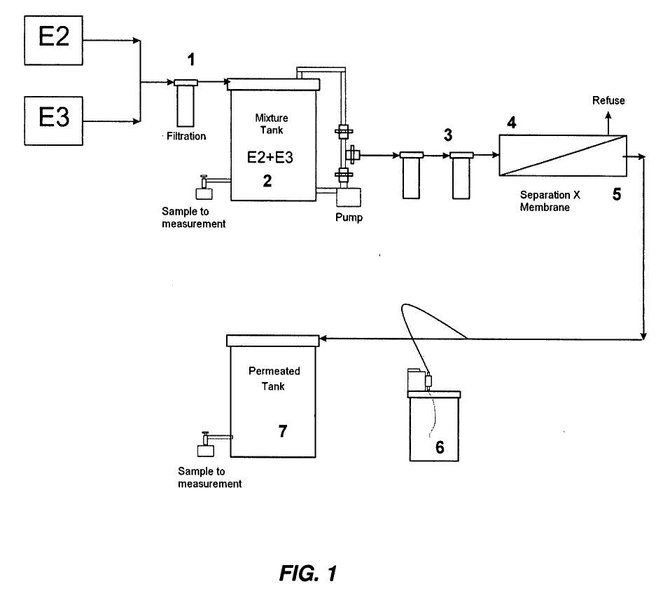

Next, a preferential, but not restrictive model is described which is used to build the equipment, object of the present patent; configuration and use can vary according to each model chosen; only one of the possibilities to build the equipment is described that lead to the completion of the described object and its mode of operation.

### DETAILED DESCRIPTION OF THE INVENTION

The process and the apparatus for reuse of liquid effluents generated in the textile finishing, laundering, dyeing and stamping process, object of the present patent, includes an apparatus made up by the following essential parts that carry out the main phases described below:

Phase 1—Screening unit for filaments/dirt retention;

Phase 2—Tank, liquid effluent homogenization and retention;

Phase 3—Liquid effluent cooling and pH correction (if necessary);

Phase 4—Aerobic bioreactor for organic load reduction;

Phase 5—Settler (circular, lamella or plate settler);

Phase 6—Sludge thickener including addition of chemical products;

Phase 7—Sludge thickening or use of drying bed (solar exposure).

### Invention Behavior

The process for reuse of liquid effluents generated in the textile finishing, laundering, dyeing and stamping process, object of the present patent, it is a single, efficient process which is easy to complete and which contains four phases that depend on the category of the generated effluent.

Table 2 below highlights the effluent matrixes of a complete washing process:

TABLE 2
Effluent matrix of the industrial washing process

| | TDS | Dissolved | Dissolved | Floating | | Sodium | | Volume |
|---|---|---|---|---|---|---|---|---|
| | (ppm) | Detergent | Dirt | Dirt | Chlorine | Bisulfite | Softener | in lts. |
| Q1 | | 450 ml | High | high | — | — | — | 400 |
| Q2 | | 50 ml | Medium | medium | — | — | — | 400 |
| Q3 | | — | Low | low | 90 ml | — | — | 200 |
| Q4 | | — | — | — | 10 ml | — | — | 200 |
| Q5 | 337 | — | — | — | — | 250 ml | 250 ml | 200 |
| | | | | | | | | 1,400 |

Analysis of the above-mentioned effluent matrix identifies basically three categories of effluents, as shown below:

1. Effluent from washing (E1) with Q1 quality and a 400-liter volume per process.

2. Effluent from rinsing (E2) with Q2 and Q5 qualities, and with a 600-liter volume per process.

3. Effluent from disinfection and neutralization (E3) with Q3 and Q4, and with a 400-liter volume per process.

These categories are relevant in identifying the performance and quality of the effluent treated in the process and the apparatus for reuse of liquid effluents generated in the textile finishing, laundering, dyeing and stamping process, object of the present patent. Therefore, the process as such consists of four main phases based on the effluent features described below;

### Treatment Process of Effluent Made Up of E2 and E3:

1—Separation phase of effluents produced by the washer
a. In this phase, E1 is initially disregarded.
b. Effluents E2 and E3 are lead separately through stop valves, pipes, and tanks to the treatment processes, and are later mixed.

2—E2 treatment phase
c. This effluent with Q2 and Q5 qualities is submitted to a 5-micron filtering process and stored in a tank, where it awaits the filtered E3 effluent.

3—E3 treatment phase
d. This effluent with Q3 and Q4 qualities, too, is submitted to a 5-micron filtering process and sent to the same tank where the E2 effluent gets stored after the 5-micron filtering.

4—E2 and E3 blending phase
e. In this phase, recirculation by centrifugal bomb is used to mix E2 and E3 effluents. This facilitates the degradation of residual free chlorine in E3 by residual bisulfite in E2.
f. Analysis of residual free chlorine in E2 and E3 mixture.
g. The mixture is sieved through a 5-micron active coal and 01-micron polypropylene filter and is then submitted to separation by membranes.
h. The permeated solution obtained from this separation is stored in a tank to which sodium hypochlorite is added to maintain a 0.2 ppm residue (this value will be reviewed during pilotage).

### Advantages

If compared to current systems, the process described above features the following advantages in relation to the following aspects: Space-saving footprint within the installation; Modular System that allows parallel or serial skid installation; effective separation of surface-active agents and ethoxylates from the effluent to be treated.

Therefore, the configuration and operation features described above clearly lead to the conclusion that the PROCESS AND APPARATUS FOR REUSE OF LIQUID EFFLUENTS GENERATED IN THE TEXTILE FINISHING, LAUNDERING, DYEING AND STAMPING PROCESS is a new equipment in relation to Prior Art, that it encompass innovation conditions, inventive activity and original industrialization, and that it therefore deserves to be granted the privilege of a Patent of Invention.

What is claimed is:

1. PROCESS AND APPARATUS FOR REUSE OF LIQUID EFFLUENTS GENERATED IN THE TEXTILE FINISHING, LAUNDERING, DYEING AND STAMPING PROCESS, a process for effluent treatment composed of E2 and E3, characterized by containing four main phases depending on the effluent category, which are:
1—Separation phase of effluents generated by the washer
a. In this phase, E1 is initially disregarded.
b. Effluents E2 and E3 are lead separately through stop valves, pipes and tanks to the treatment processes and are later blended.
2—E2 treatment phase
c. This effluent containing Q2 and Q5 qualities is submitted to a 5-micron filtering process and stored in a tank, where it awaits the filtered E3 effluent.
3—E3 treatment phase
d. This effluent with Q3 and Q4 qualities, too, is submitted to a 5-micron filtering process and sent to the same tank where the E2 effluent gets stored after the 5-micron filtering.
4—E2 and E3 blending phase
e. In this phase, recirculation by centrifugal bomb is used to mix E2 and E3 effluents. This facilitates the degradation of residual free chlorine in E3 by residual bisulfite in E2.
f. Analysis of residual free chlorine in E2 and E3 mixture.
g. The mixture is sieved through a 5-micron active coal and 01-micron polypropylene filter and is then submitted to separation by membranes.
h. The permeated solution obtained from this separation is stored in a tank to which sodium hypochlorite is added to maintain a 0.2 ppm residue (this value will be reviewed during pilotage).

2. PROCESS AND APPARATUS FOR REUSE OF LIQUID EFFLUENTS GENERATED IN THE TEXTILE FINISHING, LAUNDERING, DYEING AND STAMPING PROCESS, according to claim 1, characterized by effluents classified as (E1) Effluent resulting from a Q1-quality washing process and a 400-liter volume per process, (E2) Effluent resulting from rinsing featuring Q2 and Q5 qualities, with a 600-liter volume by process, and (E3) Effluent resulting from disinfection and neutralization containing Q3 and Q4 qualities, with a 400-liter volume by process.

3. PROCESS AND APPARATUS FOR REUSE OF LIQUID EFFLUENTS GENERATED IN THE TEXTILE FINISHING, LAUNDERING, DYEING AND STAMPING PROCESS, apparatus and treatment, characterized by essentially containing the following essential elements:
1—Screening unit for filaments/debris retention;
2—Tank, homogenization and retention of the liquid effluent;
3—Cooling of the liquid effluent and pH correction (if necessary);
4—Aerobic bioreactor for organic load reduction;
5-Settler (circular, lamella or plate settler);
6—Sludge thickener with the addition of chemical products;
7—Sludge thickening or use of drying bed (solar exposition).
